(19) United States
(12) Patent Application Publication
(10) Pub. No.: US 2005/0248692 A1
(43) Pub. Date: Nov. 10, 2005

(54) Projection television

(76) Inventor: Kyoung-Choul Jang, Suwon-si (KR)

Correspondence Address: STANZIONE & KIM, LLP, 919 18TH STREET, N.W., SUITE 440, WASHINGTON, DC, 20006, US

(21) Appl. No.: 10/964,774

(22) Filed: Oct. 15, 2004

(30) Foreign Application Priority Data
May 10, 2004 (KR) 2004-32801

(51) Int. Cl. H04N 5/217

(52) U.S. Cl. 348/748

(57) ABSTRACT

A projection television includes a light source, a fan to supply air to the light source, an exhaust duct disposed adjacent to the light source and having an inlet through which the air is taken in, an outlet through which the air cooling the light source is emitted, and a curved part to connect the inlet and the outlet, and a plurality of veins separately provided inside the exhaust duct. The projection television with the exhaust duct prevents the light generated from the light source from being externally exposed and controls the air to flow smoothly.

### CROSS-REFERENCE TO RELATED APPLICATIONS

This application claims the benefit of Korean Patent Application No. 2004-32801 filed on May 10, 2004 in the Korean Intellectual Property Office, the disclosure of which is incorporated herein in its entirety and by reference.

### BACKGROUND OF THE INVENTION

1. Field of the Invention

The present general inventive concept relates to a projection television, and more particularly, to a projection television comprising an exhaust duct to emit air cooling down a lamp.

2. Description of the Related Art

Generally, a conventional projection television employs an optical device, such as a projector, and projects an image beam to a rear surface of a screen to form an image. The projection television has an advantage in enlarging the screen, thereby resulting in an increase in demand.

The optical device comprises a light source generating light, an optical engine forming the image beam using the light from the light source, and a circuit driving the optical engine, and the image beam is projected to the screen forming the image.

Such a conventional projection television comprises a fan to cool down the light source generating heat at high temperature by applying a forced cooling air method.

The air supplied by the fan cools down the light source and is emitted through an exhaust duct.

However, if the exhaust duct is placed adjacent to the light source, the light from the light source is exposed outside and consequently degrades an external appearance of the projection television.

### SUMMARY OF THE INVENTION

In order to solve the foregoing and/or other problems, it is an aspect of the present general inventive concept to provide a projection television with an exhaust duct to prevent light generated from a light source from being exposed outside and to simultaneously control air cooling the light source to be smoothly emitted.

Additional aspects and/or advantages of the invention will be set forth in part in the description which follows and, in part, will be obvious from the description, or may be learned by practice of the invention.

The foregoing and/or other aspects of the present general inventive concept may be achieved by providing a projection television comprising a light source, a fan to supply air to the light source, an exhaust duct disposed adjacent to the light source and comprising an inlet through which the air is taken in, an outlet through which the air is emitted, and a curved part to connect the inlet and the outlet, and a plurality of veins separately provided inside the exhaust duct.

According to an aspect of the present general inventive concept, the plurality of veins can be provided along a curvature of the curved part of the exhaust unit.

According to another aspect of the present general inventive concept, the plurality of veins comprises a light absorbing material.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a perspective view of a projection television according to an embodiment of the present general inventive concept;

FIG. 2 is a sectional view of the projection television, taken along a line 11-11 of FIG. 1;

FIG. 3 is a perspective view of a rear portion of an optical engine of the projection television in FIG. 1;

FIG. 4 is an exploded perspective view of an exhaust duct of the optical engine in FIG. 3; and

FIG. 5 is a sectional view of the exhaust duct in FIG. 4.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures. In the accompanying drawings, a description of a projection television will be mainly focused on an exhaust duct of an optical engine.

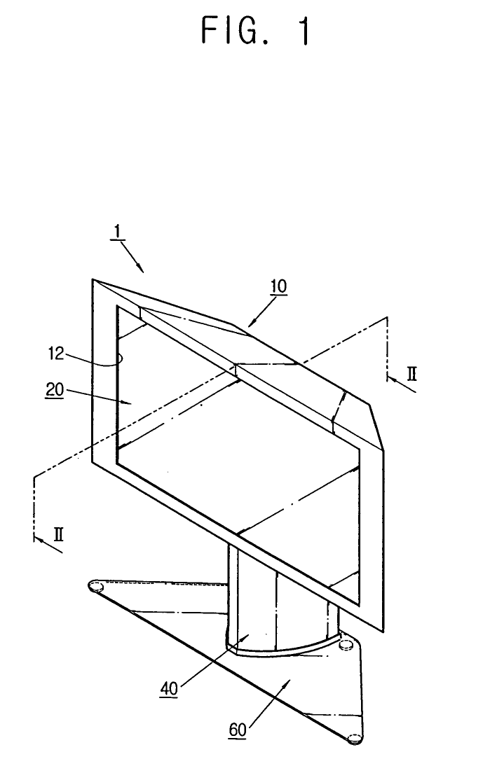

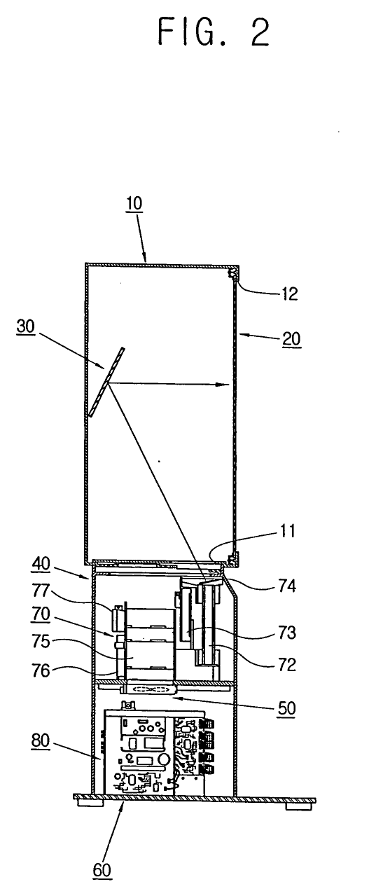

As shown in FIGS. 1 and 2, a projection television 1 according to an embodiment of the present general inventive concept may comprise an optical engine 70 to form and project an image beam, a circuit 80 to drive the optical engine 80, a fan 50 to supply air to cool down the optical engine 70 and the circuit 80, a main cabinet 40 to accommodate the optical engine 70, the circuit 80 and the fan 50, a cabinet supporter 60 to support the main cabinet 40, a reflection mirror 30 to reflect the image beam projected from the optical engine 70, a screen 20 to form an image using the image beam reflected by the reflection mirror 30, and a screen cabinet 10 to which the screen 20 is installed.

An opening 12 can be provided in a front side of the screen cabinet 10, and thus the screen 20 can be exposed outside therethrough, and the reflection mirror 30 can be disposed on an inner rear portion of the screen cabinet 10 to reflect the image beam projected from the optical engine 70 to the screen 20. In addition, a projection hole 11 having a predetermined size can be provided at a bottom side of the screen cabinet 10 so that the image beam from the optical engine 70 can be projected to the reflection mirror 70 therethrough.

The circuit 80 can drive the optical engine to form the image beam based on image signal information transmitted from an external source through an antenna or a cable, etc., or transmitted from another external source or a storage device through multimedia devices, such as a DVD, a VCR, a computer, etc.

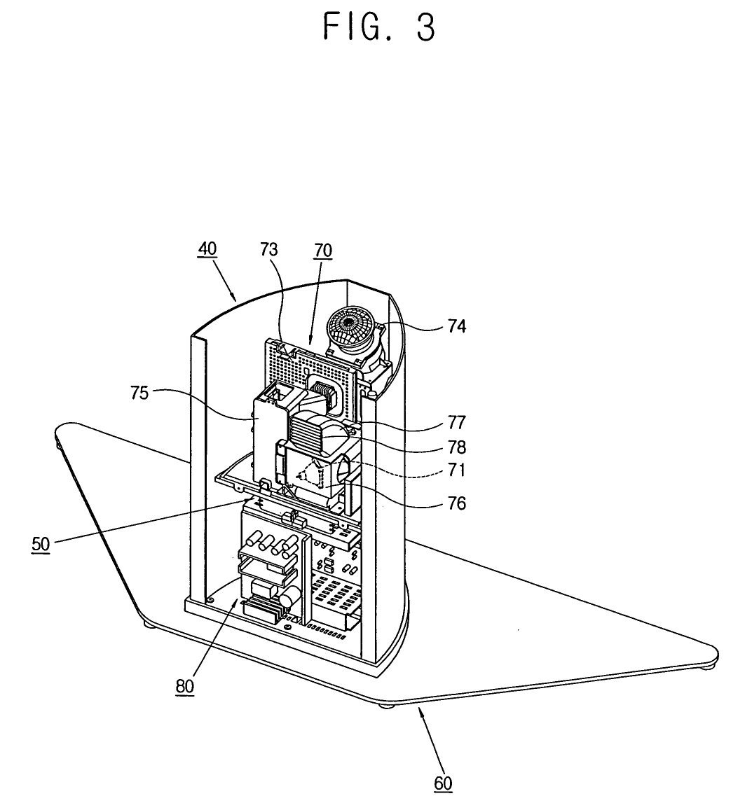

As shown in FIGS. 2 and 3, the optical engine 70 may comprise a light source 71,an introducing duct 76 to accommodate the light source 71 and to introduce air supplied by the fan 50 to the light source 71, an exhaust duct 77 connected to the introducing duct 76 to emit the air cooling down the light source 71, a plurality of veins 78 separately provided in the exhaust duct 77, a color filter wheel (not shown) to filter the light emitted from the light source 71, an illuminator 72 to convert the light passing through the color filter wheel into evenly parallel light and to focus the parallel light, a display device 73 to visualize the light from the illuminator 72 to the image, a projector lens 74 to project the image beam containing the image visualized by the display device in a large scale, and a ballast 75 to provide power to the optical engine 70.

A short arc typed metal halide lamp or a high-power discharge lamp, such a xenon lamp, can be used as the light source 71 to improve luminance and color rendering of the image projected from the optical engine 70. Further, the light source 71 can be provided on a path through which the air supplied by the fan 50 flows.

An axial flow fan can be used as the fan 50 to blow the air along an axial direction, and the fan 50 can be disposed adjacent to the light source 71. Here, the fan 50 can be provided at a lower portion of the light source 71 to supply the air from the lower portion to an upper portion of the light source 71.

The air disposed in a lower cabinet of the main cabinet 40 can cool down the circuit 80, and the air cooling the circuit 80 is drawn into an inside of the upper cabinet of the main cabinet 40 by the fan 50 to be used to cool down the light source 71 disposed in the introducing duct 76. Therefore, the fan can control the air to cool down the light source 71 as well as the circuit 80.

The introducing duct 76 can introduce the air from the fan 50 to the light source 71. In other words, a lower portion of the introducing duct 76 can be connected to the fan 50 while an upper portion of the introducing duct 76 is connected to the exhaust duct 77. Thus, the air supplied from the fan 50 can move upward to cool down the light source 71 provided inside of the introducing duct 76, and the air cooling down the light source 71 can be emitted through the exhaust duct 77. Further, the exhaust duct 77 may comprise a portion to be opened so that the light source 71 emits the light therethrough toward the display device 73. In addition, at least a side of the introducing duct 76 may be provided a sub duct (not shown) to introduce the air drawn from the lower cabinet to cool down other components excluding the light source 71, if necessary.

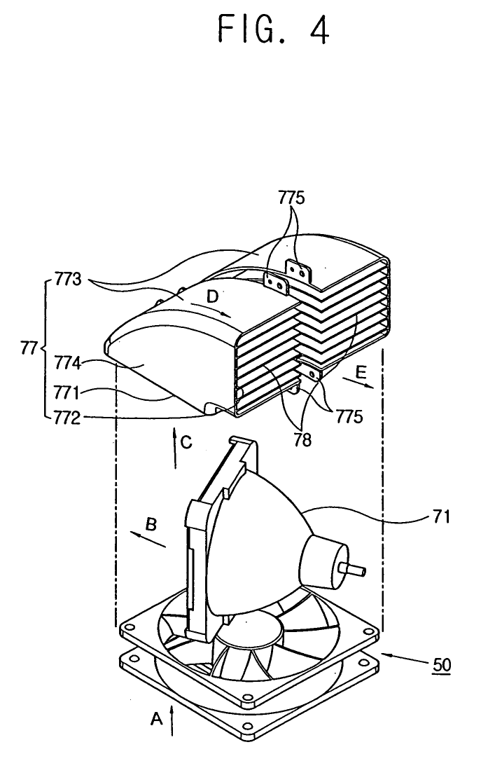

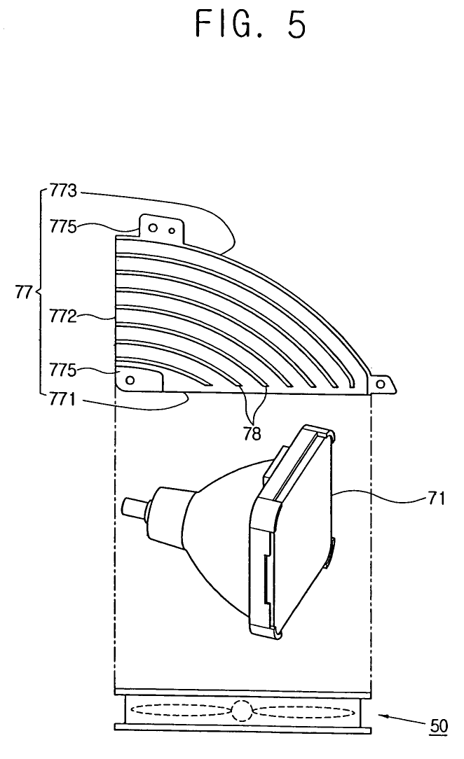

As shown in FIGS. 4 and 5, the exhaust duct 77 may comprise an inlet 771 to take in the air from the introducing duct 76, an outlet 772 to emit the air through a rear surface of the main cabinet 40, a bent unit (curved part) 773 to form an upper surface of the exhaust duct 77 and to connect the inlet 771 and the outlet 772. Further, the exhaust duct 77 may comprise side portions 774 to form sidewalls of the exhaust duct 77. Accordingly, the air cooling down the light source 71 provided in the introducing duct 76 can be emitted to a bottom surface or an inside of the upper cabinet of the main cabinet 40 through the outlet 772 of the exhaust duct 77. Further, the exhaust duct 77 can be laterally divided into at least two identical sections. Each of the divided exhaust ducts 77 may comprise at least one flange 775 with a pair of combining holes respectively formed on the bent unit 773 between the inlet 771 and the outlet 772, and the two sections can be connected to each other by a screw (not shown) through combining holes.

The plurality of veins 78 arranged at a given interval may have a streamline shape formed along a curved surface 773a of the curved part 773 so that the cooled air can flow smoothly through an inside of the exhaust duct 77. The veins 78 can be arranged at the given interval so that the air can flow smoothly through the inside of the exhaust duct 77 while preventing the light from the light source 71 from leaking or being exposed outside through the exhaust duct 77. Further, the veins 78 can uniformly distribute heat generated from the light source 71.

In an aspect of the present general inventive concept, the veins 78 may comprise a light absorbing material. In other words, the veins 78 may be mode of the light absorbing material, or the light absorbing material may be coated on a surface of the veins 78. The light absorbing material may be in flat dark color to effectively absorb the light.

In another aspect of the present general inventive concept, the fan 50 can be provided to the lower portion of the light source 71, and the introducing duct 76 can be divided into the upper portion and the lower portion, and thus the upper portion of the introducing duct 76 can be connected to the exhaust duct 77. However, the fan 50 may be provided at a side of the light source 71, so that the introducing duct 76 may be laterally provided with the fan 50, and the exhaust duct 77 may be disposed opposite to the fan 50 with respect to the light source 71 centered in the introducing duct 76.

The air is blown in a direction of an arrow A by the fan 50 while the light is emitted from the light source 71 in a direction of an arrow B. The air cooling the light source 71 flows into the inlet 772 in a direction of an arrow C, passes along a direction of an arrow D in the bent unit 773, and exits the outlet 772 in a direction of an arrow E. When the fan 50 is disposed on the side of the introducing duct 76, the air is blown toward the light source 71 in a direction having an angle with the direction of the arrow B.

With these configurations, the projection television 1 according to the embodiment of the present general inventive concept can control the air to smoothly flow through the curved part 773 using the plurality of separate veins 78 which are provided along the curvature of the curved part 773 of the exhaust duct 77 to emit the air cooling the light source 71, and at the same time to prevent the light generated from the light source 71 from being exposed outside through the exhaust duct 77 which is placed adjacent to the light source 71. The veins 78 can have different lengths along the direction D between the inlet 771 and the outlet 772.

In addition, the heat generated from the light source 71 can be uniformly distributed through the plurality of veins placed inside of the exhaust duct 77, thereby preventing a certain portion of the exhaust duct 77 from being heated at relatively high temperature.

Although a few embodiments of the present invention has been shown and described, it will be appreciated by those skilled in the art that changes may be made in these embodiments without departing from the principles and spirit of the invention, the scope of which is defined in the appended claims and their equivalents.

1. A projection television comprising:
a light source;
a fan to supply cooled air to the light source;
an exhaust duct disposed adjacent to the light source and comprising an inlet through which the air is taken into the exhaust duct, an outlet through which the air is emitted from the exhaust duct, and a curved part to connect the inlet and the outlet; and
a plurality of veins separately provided inside the exhaust duct.

2. The projection television of claim 1, wherein the plurality of veins are provided along a curvature of the curved part of the exhaust duct.

3. The projection television of claim 2, wherein the plurality of veins comprise a light absorbing material.

4. The projection television of claim 1, wherein the plurality of veins comprise a light absorbing material.

5. The projection television of claim 1, wherein the veins are parallel to each other and have different lengths.

6. The projection television of claim 1, further comprising:
a main cabinet having a lower cabinet and an upper cabinet;
a circuit disposed in the lower cabinet to generate a driving signal;
an optical engine disposed in the upper cabinet and having the light source driven by the driving signal; and
a screen cabinet disposed on the upper cabinet of the main cabinet and having a screen and a reflection mirror to reflect an image on the screen according to the light,
wherein the fan is disposed between the lower and upper cabinets of the main cabinet to control the air to flow from the lower cabinet to the upper cabinet.

7. The projection television of claim 6, wherein the fan blows the air from the lower cabinet to the upper cabinet 50 so that the circuit and the light source are cooled down.

8. The projection television of claim 6, wherein the fan controls the air to flow from the lower cabinet to the upper cabinet in a first direction and controls the air to flow through the light source, and the light source emits the light in a second direction substantially perpendicular to the first direction.

9. The projection television of claim 8, wherein the air passing through the light source enters the exhaust duct through the inlet in a third direction having an angle with the second direction.

10. The projection television of claim 9, wherein the air passing through the curved part in a fourth direction exits the outlet in a fifth direction having an angle with the third direction.

11. The projection television of claim 1, where the veins have a shape substantially same as a surface of the curved part of the exhaust duct.

12. The projection television of claim 1, wherein the veins have substantially the same curvature as the curved part.

13. The projection television of claim 1, wherein the veins are extended from the inlet to the outlet.

14. The projection television of claim 1, wherein the inlet, the curved part are the outlet are formed in a signal monolithic body.

15. The projection television of claim 1, wherein the veins are coated with a non-reflective material.

16. The projection television of claim 1, wherein the curved part of the exhaust duct is curved so that a portion of the light emitted from the light source is blocked by the curved part of the exhaust duct.

17. The projection television of claim 1, wherein the veins are disposed in the curved part, and each of the veins is extended from the inlet to the outlet.

18. The projection television of claim 17, wherein the each of the veins is curved so that the light emitted from the light source is prevented by the veins from being transmitted from the inlet to the outlet in a straight line direction.

19. The projection television of claim 1, further comprising:
an introducing duct disposed between the fan and the exhaust duct to accommodate the light source.

20. The projection television of claim 19, wherein the introducing duct is coupled between the fan and the exhaust duct.

21. A projection television comprising:
a main cabinet having a lower cabinet and an upper cabinet;
a circuit disposed in the lower cabinet to generate a driving signal;
an optical engine disposed in the upper cabinet and having a light source, a display device, and a projector lens;
a fan disposed between the lower cabinet and the upper cabinet to control air to flow from the lower cabinet to the upper cabinet;
an introducing duct coupled to the fan to accommodate the light source and to guide the air to pass through the light source; and
an exhaust duct coupled to the introducing duct to receive the air passing through the light source and to guide the air to an inside of the upper cabinet.

22. The projection television of claim 21, wherein the exhaust duct comprises an inlet, an outlet, and a plurality of veins disposed between the inlet and the outlet to prevent a certain portion of the exhaust duct from being heated at relatively high temperature.

23. The projection television of claim 21, wherein the exhaust duct comprises an inlet, an outlet, and a plurality of veins disposed therein between the inlet and the outlet, and the veins have different length in a direction from the inlet to the outlet.

24. The projection television of claim 21, wherein the exhaust duct comprises an inlet, an outlet, and a plurality of veins extended from the inlet to the outlet, and the veins have different length in a direction from the inlet to the outlet and the same curvature.

25. The projection television of claim 21, wherein the exhaust duct comprises an inlet, an outlet disposed to have an angle with the inlet, a bent unit disposed between the inlet and the outlet, and a plurality of veins disposed in the bent unit, extended from the inlet to the outlet along the bent surface, and having different length in a direction from the inlet to the outlet.

26. The projection television of claim 25, wherein the light source emits the light in a direction, and the bent unit comprises a bent surface bent from the inlet to the outlet in another direction other than the direction of the light.
